(19) United States
(12) Patent Application Publication
(10) Pub. No.: US 2013/0205352 A1
(43) Pub. Date: Aug. 8, 2013

(54) System and Method for Video Streaming to Display Device Using Parasitically Powered Receiver

(71) Applicants: Joseph Thaddeus Lipowski, Norwell, MA (US); Chaitanya Kanojia, West Newton, MA (US); Michael John Helgeson, Sudbury, MA (US)

(72) Inventors: Joseph Thaddeus Lipowski, Norwell, MA (US); Chaitanya Kanojia, West Newton, MA (US); Michael John Helgeson, Sudbury, MA (US)

(73) Assignee: AEREO, INC., Long Island City, NY (US)

(21) Appl. No.: 13/364,826

(22) Filed: Feb. 2, 2012

(51) Int. Cl. H04N 21/60

(52) U.S. Cl. 725/81

(57) ABSTRACT

A method and system for streaming to wirelessly stream multimedia content through computing devices to parasitically powered receivers without the use of an additional AC power cord. The computing devices access streaming content and wirelessly transmit the streaming content to parasitically powered receivers. The parasitically powered receivers decode and demodulate the streamed content and then transfer the streamed content to the display devices.

### BACKGROUND OF THE INVENTION

Video and audio content is typically provided to display devices such as televisions via set top boxes supplied by cable or satellite providers. The set top boxes demodulate and decode incoming signals to produce video and audio signals compatible with standard interfaces such as composite video and audio, component audio and video, and HDMI (High Definition Multi-Media Interface), to list a few examples. The Thunderbolt interface is another example. The demodulated and decoded signals are then transmitted to the display devices with interface cables. The set top boxes are powered by standard home AC power and are known to be large power consumers, even when in a sleep state.

An alternative means to receive video and audio content is to access Internet streaming sources with streaming media devices. Two examples of streaming media devices are the Roku streaming player by Roku Inc. and the Apple TV media receiver by Apple Inc. Typically, the streaming media devices connect to the Internet and provide streaming content from the Internet streaming sources.

These streaming media devices can be difficult to set up because they often require multiple interface cables to set up. For example, an interface cable is required to connect the streaming media device to the display device, an Ethernet cable is required to connect the streaming media device to the Internet, and a power cord is required to supply power to the streaming media device. Even if the streaming media device is able to wirelessly access the Internet, such as via a home access point or router, a wireless connection must still be configured for the streaming media device.

Another method for transferring audio and video content to the display devices is to directly connect computing devices such as personal computers, tablet computers or a smartphones to the display device with an interface cable. When connected with an interface cable, any content accessed by or resident on the computing device can be transferred to the display device for display.

### SUMMARY OF THE INVENTION

A common problem is that the set top boxes and streaming media devices are often difficult to set up. For example, the set top boxes are typically installed by trained technicians and consumers typically have to schedule appointments days or weeks in advance. This leads to increased costs and logistical complexity. Consumers typically try to install streaming media devices, but may not possess the required expertise to properly set up the streaming media devices.

Additionally, it is becoming more common for consumers to have multiple set top boxes and streaming media devices. Each additional device further increases the overall complexity of the system because all the devices need to be properly connected and configured for the system to function. Additionally, the desired input to the display devices needs to be selected among the different inputs used by the different boxes and devices.

Even connecting the computing device directly to the display device often requires a specific interface cable and access to the rear of the display device each time the computing device is connected to the display device. The consumer could leave the interface cable permanently connected to the display device, but then the interface cable is left hanging in front of the display device. Furthermore, when in use, the computing device is tethered to the television by the interface cable, which is inconvenient.

The present system and method concern an approach to wirelessly stream content from computing devices to receivers, which can be parasitically powered. The receivers receive the streaming content, decode and demodulate the streamed content, and then transfer the streamed content to the display devices via a physical port, such as an HDMI interface input port, which preferably provides power back to the receivers.

Prior to use, users connect the parasitically powered receivers to the physical ports of the display devices. The parasitically powered receivers utilize energy harvesting circuits to harvest power from the physical ports of the display devices. The harvested energy is stored in power stores to later power the parasitically powered receivers.

In general, according to one aspect, the invention features a method for wireless streaming of content from a computing device to a display device through a physical port on the display device. The method includes connecting a parasitically powered receiver to the physical port of the display device and the parasitically powered receiver drawing power from the display device through the physical port. The method further includes the parasitically powered receiver receiving streamed content via a wireless connection from the computing device, decoding the content, and supplying the content on the physical port for display on the display device.

In general, according to another aspect, the invention features a system for wireless streaming of content from a computing device. The system includes a display device that includes a physical port for receiving content and a parasitically powered receiver connected to the physical port of the display device, the parasitically powered receiver drawing power from the display device through the physical port. The parasitically powered receiver receives streamed content via a wireless connection from the computing device, decodes the streamed content, and supplies the streamed content on the physical port for display on the display device.

In general, according to another aspect, the invention features a system for wireless streaming of content from a computing device. The system comprises a display device that includes a physical port for receiving content and a receiver connected to the physical port of the display device. The receiver receives streamed content via a wireless connection from the computing device, which is established by a pairing application on the computing device, decodes the streamed content, and supplies the streamed content on the physical port for display on the display device.

In one example, the receiver is mechanically supported by the physical port.

In general, according to another aspect, the invention features a system for wireless streaming of content from a computing device. The system comprises a display device that includes a physical port for receiving content and a receiver connected to the physical port of the display device. The receiver receives streamed content via a peer-to-peer wireless connection from the computing device, decodes the streamed content, and supplies the streamed content on the physical port for display on the display device.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram showing the relationship between Internet streaming sources, a television streaming service, local network content sources, the Internet, the computing device, the parasitically powered receiver, and the display device.

FIG. 2 is a flowchart illustrating the steps performed by the parasitically powered receiver to harvest power from the physical port of the display device.

FIG. 3 is a flowchart illustrating the steps performed by the device pairing application on the computing device.

FIG. 4 is a flowchart illustrating the steps performed by the receiver to receive streamed content and transfer it to the display device.

### DETAILED DESCRIPTION OF THE PREFERRED EMBODIMENTS

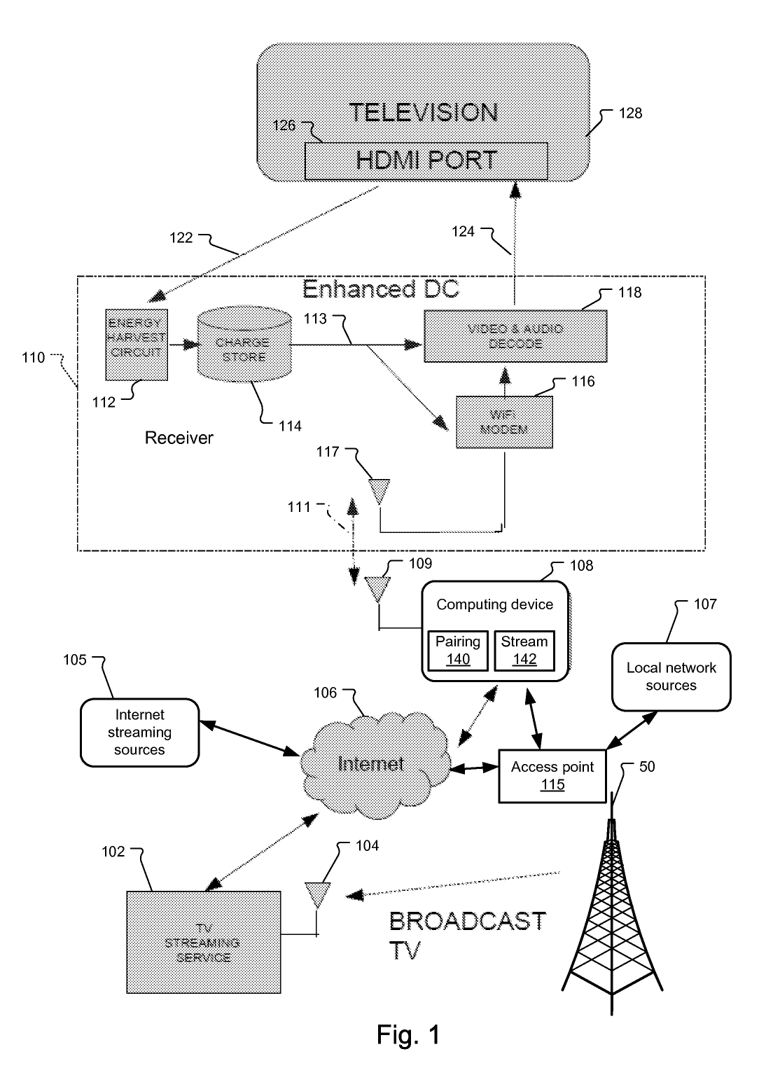

FIG. 1 is a block diagram showing the relationship between the television streaming service 102, Internet streaming sources 105, local network sources 107, the Internet 106, the computing device 108, the receiver 110, and the display device 128.

In one embodiment, over the air broadcasts from broadcasting entities 50 are captured by the television streaming service 102. The television streaming service 102 utilizes an antenna 104 (or array of antennas) to capture the over the air broadcasts. Typically, the captured over the air broadcasts are decoded, stored and streamed to computing devices by the television streaming service 102. One example of a television streaming service is described in U.S. patent application Ser. No. 13/299,186, filed on Nov. 17, 2011 by Kanojia and Lipowski, now U.S. Pat. Appl. Publ. No. ______, (“System and Method for Providing Network Access to Antenna Feeds”), which is incorporated herein by reference in its entirety.

The television streaming service 102 transfers the streamed content to the computing device 108 through a public data network such as the Internet 106 or a mobile broadband network and/or data service provider network. The mobile broadband network is typically a 3G (third generation) or 4G (fourth generation) mobile broadband network. In a typically scenario, the computing device 108 connect to the Internet via the access point 115 that maintains a home or local area wireless network. The streamed content is generally transferred with HTTP Live Streaming (HLS) or HTTP Dynamic Streaming (HDS), in specific examples. HLS is a HTTP-based media streaming communications protocol developed by Apple Inc. as part of its QuickTime software system that uses a sequence of HTTP-based file downloads. HDS is a communications protocol by Adobe System Inc. The player may switch between streams of different quality based on the network bandwidth and the computing device's resources. The computing device 108 is typically a mobile phone (or smartphone) with Internet connectivity such as an iPhone mobile computing device by Apple Inc. or a smartphone running the Android operating system by Google Inc. In alternative embodiments, the computing device 108 is a laptop computer, a tablet computer, or a gaming console, to list a few examples.

In an alternative embodiment, the computing device 108 accesses the streamed content from Internet streaming sources 105 via the Internet 106. The Internet streaming sources 105 typically include content hosting websites such as video sharing websites, streaming radio services, or movie streaming services, to list a few examples.

In a typical implementation, streamed content is accessed with content streaming applications 142 that are installed on the computing device 108. The content streaming applications pass the streamed content to the receiver 110, sometimes without modifying the streamed content. In the illustrated example, the content streaming applications 142 are software applications invoked by user of the computing device 108 to access streamed content hosted by the television streaming service 102 or Internet streaming sources 105, for example. Multiple content streaming applications are typically installed on the computing device 108 because the television streaming service 102 and different Internet streaming sources 105 only provide access to their own content. In an alternative embodiment, the television streaming service 102 and Internet streaming services 105 are accessed via an Internet browser installed on the computing device 108. Control of the program is provided on the computing device 108.

In another alternative embodiment, the computing device 108 accesses the streamed content from the local network sources 107. The local network sources 107 are typically other computing devices on the same local area network as the computing device 108. The local network sources 107 include servers, storage area network device, desktop computers, laptop computers, tablet computers, smartphones, portable music players, or set top boxes, to list a few examples. The streamed content is generally stored in storage mediums of the local network sources 107 and shared with the computing device 108 via the existing local area network. In this scenario, a centralized communication device such as a wireless access point 115 or router manages network communications traffic between all of the devices (sometimes referred to as clients) in the local area network.

In another alternative embodiment, the streamed content is accessed from a storage medium of the computing device 108 itself. The streamed content could be content that has been previously accessed and/or downloaded or content that has been uploaded to the computing device by the user, to list a few examples.

The streamed content is transmitted from an antenna 109 of the computing device 108 to the receiver 110 via a wireless connection 111.

The wireless connection 111 is preferably configured with a device pairing application 140 on the computing device 108 in one implementation. The device pairing application 140 searches for available receivers and enables a user to select an available receiver. Based on the user selection, the device pairing application 140 establishes the wireless connection 111 between the computing device 108 and the receiver 110.

In a typical implementation, the wireless connection 111 is a peer to peer WiFi connection. The peer to peer WiFi connection is a wireless connection between two devices that enables the two devices to communicate directly with each other without a centralized communication device or existing local area network. The receiver 110 includes an antenna 117 and WiFi modem 116 to receive the streamed content from the computing device 108.

In an alternative embodiment, the wireless connection 111 is a Bluetooth connection. Bluetooth is a wireless protocol for short range transmission that can be used to transmit audio and video signals. In another alternative embodiment, the wireless connection 111 communicates through the access point or router of the existing local area network.

The receiver 110 is a streaming media device that receives the streamed content from the computing device 108. In a typical implementation, the streamed content from the computing device 108 is transmitted to the receiver 110 in a compressed video format such H.264 (or MPEG-4 part 10) and a compressed audio format such as AAC (advanced audio coding) format. A video and audio decoder (decoder) 118 of the device 110 decodes and demodulates the streamed content. The receiver 110 then, in one example, encodes the streamed content to an uncompressed format of the physical port 126 of the display device 128 using TMDS (Transition-minimized differential signaling). The streamed content is then transmitted to the physical port 126 and displayed on the display device 128.

In the illustrated example, the connection between the receiver 110 and physical port 126 is shown as a first connection 124 that transmits audio and video signals (i.e., the streamed content) from the receiver 110 to the physical port 126 and a second connection 122 that transmits power from the physical port 126 to the receiver 110 in one embodiment. In this way, in one embodiment, the receiver 110 is a parasitically powered device, that is it receives DC power from the display device 128 via the physical port 126. In a typical implementation, the receiver 110 plugs directly into the port so as to be mechanically supported by the port 126, but in other examples, an interface cable carries the streamed content to and the power from the physical port 126.

The physical port 126 is typically a HDMI connection. In alternative embodiments, other interfaces are used such as the Thunderbolt interface connection by Apple Inc., the IEEE 1394 (or Firewire) interface connection by Apple Inc., a USB (Universal Serial Bus) interface connection, or an Ethernet interface utilizing power over Ethernet.

In some cases, the power required by the parasitically powered receiver 110 exceeds the power that is instantaneously available from the physical port 126. This is because the HDMI connection, for example, only provides 250 milliWatts of power, while the parasitically powered receiver 110 requires approximately 1 to 5 Watts, with current technology. On the other hand, the Thunderbolt interface specification provides for up to 10 Watts. Therefore, the parasitically powered receiver 110 includes an energy harvesting circuit 112 and a power store (or charge store) 114, in a current embodiment. The energy harvesting circuit 112 harvests power supplied by the physical 126 of the display device. The power store 114 stores the power harvested by the harvesting circuit. Generally, the power store 114 is a battery or a super-capacitor.

Alternative embodiments of the parasitically powered receiver 110 may not require the energy harvesting circuit 112 and power store 114 because other interface connections supply different amounts of power. Similarly, if the power consumption of the parasitically powered receiver 110 is reduced, then the energy harvesting circuit 112 and power store 114 cease to be required.

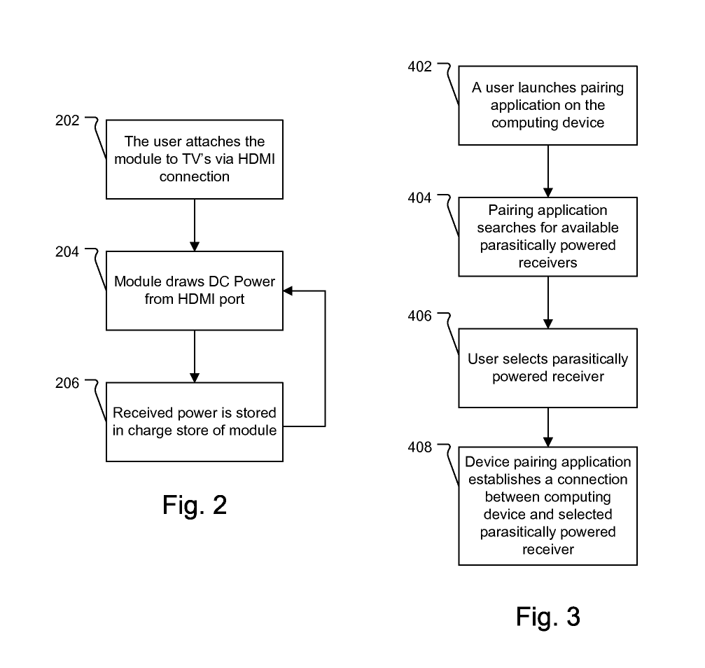

FIG. 2 is a flowchart illustrating the steps performed by the receiver 110 to harvest and store power from the display device 128, according to one embodiment.

In the first step 202, the user attaches the parasitically powered receiver 110 to the physical port 126 of the display device 128. In the next step 204, the parasitically powered receiver 110 draws power from the physical port 126 of the display device 128. The harvested power is then stored in the power store 114 of the parasitically powered receiver 110 in step 206.

In other embodiments, the receiver 110 is powered by other sources. In one example, power is provided by an internal battery. In another example, the receiver 110 connects to a standard AC power source.

FIG. 3 is a flowchart illustrating the steps performed by the device pairing application 140 on the computing device 108.

In the first step 402, a user launches the device pairing application 140 on the computing device 108. In the next step 404, the device pairing application 140 searches for available receivers. In the next step 406, the user selects an available receiver. In the next step 408, the device pairing application 140 establishes the wireless connection 111 between the computing device 108 and receiver 110. Then, the computing device 108 streams video content to the receiver 110 over the connection 111.

In some embodiments, this pairing is required only in the initialization of the relationship, that is, on the initial usage. In this case, subsequent pairing is autonomous.

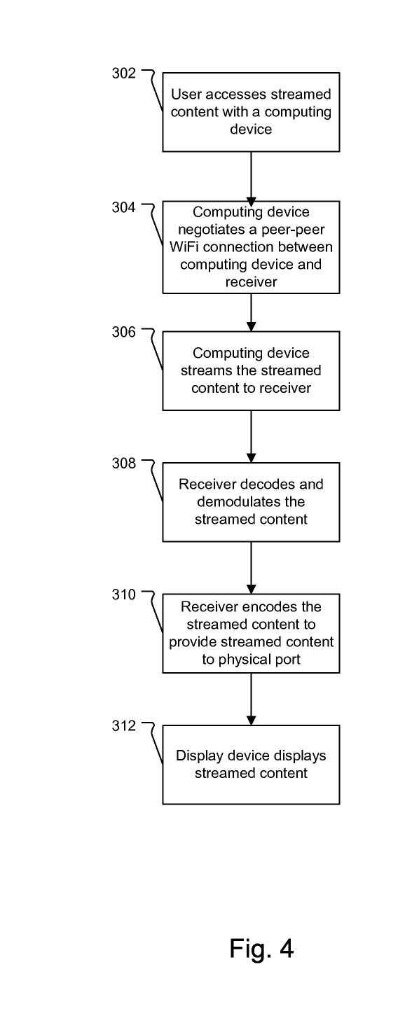

FIG. 4 is a flowchart illustrating the steps performed to transmit streamed content to the display device 128.

In the first step 302, the user accesses the streamed content with the computing device 108. Generally, the streamed content is accessed from the television service 102, the Internet streaming sources 105, local network sources 107, or files residing on the computing device. In the next step 304, the computing device 108 negotiates a peer-to peer WiFi, or other wireless, connection between the computing device 108 and the receiver 110. In the next step 306, the computing device 108 device streams the streamed content to the receiver 110.

In the next step 308, the decoder 118 of the receiver 110 demodulates and decodes the streamed content. In the next step 310, the receiver 110 encodes the streamed content to provide the streamed content to the physical port 126 of the display device 128. Typically the streamed content is encoded by TMDS. In the next step 312, the display device 128 displays the streamed content received from the receiver 110.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for wireless streaming of content from a computing device to a display device through a physical port on the display device, the method comprising:
connecting a parasitically powered receiver to the physical port of the display device;
the parasitically powered receiver drawing power from the display device through the physical port; and
the parasitically powered receiver receiving streamed content via a wireless connection from the computing device, decoding the content, and supplying the content on the physical port for display on the display device.

2. The method according to claim 1, wherein the physical port is an HDMI port.

3. The method according to claim 1, further comprising storing the power drawn from the display device in a power store of the parasitically powered receiver.

4. The method according to claim 3, wherein the power store is a battery.

5. The method according to claim 3, wherein the power store is a capacitor.

6. The method according to claim 1, further comprising the computing device accessing the streamed content from local network sources.

7. The method according to claim 1, further comprising the computing device accessing the streamed content via a mobile broadband network.

8. The method according to claim 1, wherein the computing device is a laptop, tablet, or desktop computer or mobile computing device.

9. The method according to claim 1, further comprising transferring the streamed content from the computing device to the parasitically powered receiver through a peer to peer WiFi connection.

10. The method according to claim 1, further comprising transferring the streamed content from the computing device to the parasitically powered receiver through a Bluetooth connection.

11. The method according to claim 1, further comprising transferring the streamed content from the computing device to the parasitically powered receiver through a wireless access point of a local area network, on which the receiver and the computer device are clients.

12. The method according to claim 1, wherein the decoding of the content and the supplying of the content on the physical port comprises the parasitically powered receiver converting a compressed video format received from the computing device to an uncompressed video format of the physical port.

13. The method according to claim 12, wherein the compressed video format is H.264 and the uncompressed video format is encoded using Transition-minimized differential signaling.

14. The method according to claim 1, further comprising invoking a content streaming application on the computing device that enables the computing device to access the streamed content from Internet streaming sources.

15. The method according to claim 1, further comprising accessing the streamed content from Internet streaming sources with an Internet browser installed on the computing device.

16. The method according to claim 1, further comprising the computing device accessing the streamed content from a storage medium of the computing device or storage mediums of other devices on a local area network, on which the computing device is a client.

17. The method according to claim 1, further comprising invoking a device pairing application on the computing device that searches for available parasitically powered receivers and enabling a user to select one of the parasitically powered receivers.

18. The method according to claim 17, further comprising the device pairing application establishing the wireless connection between the computing device and the selected parasitically powered receiver.

19. The method according to claim 1, further comprising invoking a content streaming application on the computing device that enables the computing device to access the streamed content of a television streaming service.

20. The method according to claim 1, further comprising accessing the streamed content of a television streaming service with an Internet browser installed on the computing device.

21. A system for wireless streaming of content from a computing device, the system comprising:
a display device that includes a physical port for receiving content; and
a parasitically powered receiver connected to the physical port of the display device, the parasitically powered receiver drawing power from the display device through physical port; and
wherein the parasitically powered receiver receives streamed content via a wireless connection from the computing device, decodes the streamed content, and supplies the streamed content on the physical port for display on the display device.

22. The system according to claim 21, wherein the physical port is an HDMI port.

23. The system according to claim 21, further comprising: a harvest circuit for obtaining power from the physical port of the display device, and a power store within the parasitically powered receiver to store the power from harvest circuit.

24. The system according to claim 23, wherein the power store is a battery.

25. The system according to claim 23, wherein the power store is a capacitor.

26. The system according to claim 21, wherein the computing device accesses the streamed content from local network sources.

27. The system according to claim 21, wherein the computing device accesses the streamed content via a mobile broadband network.

28. The system according to claim 21, wherein the computing device is a laptop, tablet, or desktop computer or mobile phone.

29. The system according to claim 21, wherein the computing devices transfers the streamed content to the parasitically powered receiver through a peer to peer WiFi connection.

30. The system according to claim 21, wherein the computing devices transfers the streamed content to the parasitically powered receiver via a Bluetooth connection.

31. The system according to claim 21, wherein the computing devices transfers the streamed content to the parasitically powered receiver through an access point of a local area wireless network, on which the receiver and the computer device are clients.

32. The system according to claim 21, further comprising a decoder for converting a compressed video format received from the computing device to an uncompressed video format of the physical port.

33. The system according to claim 32, wherein the compressed video format is H.264 and the uncompressed video format is encoded using Transition-minimized differential signaling.

34. The system according to claim 21, wherein the computing device includes a content streaming application that enables the computing device to access the streamed content from Internet streaming sources.

35. The system according to claim 21, wherein the computing device includes an Internet browser for accessing the streamed content from Internet streaming sources.

36. The system according to claim 21, wherein the computing device includes a storage medium to store streamed content.

37. The system according to claim 21, wherein the computing device accesses streamed content stored in storage mediums of other devices on a local area network, on which the computing device is a client.

38. The system according to claim 21, wherein the computer device includes a device pairing application that searches for available parasitically powered receivers and enables a user to select one of the parasitically powered receivers.

39. The system according to claim 38, wherein the device pairing application of the computer device establishes the wireless connection between the computing device and the selected parasitically powered receiver.

40. The system according to claim 21, wherein the computing device includes a content streaming application that enables the computing device to access the streamed content from a television streaming service.

41. The system according to claim 21, wherein the computing device includes an Internet browser to access the streamed content from a television source.

42. A system for wireless streaming of content from a computing device, the system comprising:
a display device that includes a physical port for receiving content; and
a receiver connected to the physical port of the display device; and
wherein the receiver receives streamed content via a wireless connection from the computing device, which is established by a pairing application on the computing device, decodes the streamed content, and supplies the streamed content on the physical port for display on the display device.

43. The system according to claim 42, wherein the receiver is mechanically supported by the physical port.

44. A system for wireless streaming of content from a computing device, the system comprising:
a display device that includes a physical port for receiving content; and
a receiver connected to the physical port of the display device; and
wherein the receiver receives streamed content via a peer-to-peer wireless connection from the computing device, decodes the streamed content, and supplies the streamed content on the physical port for display on the display device.
